(19) United States
(12) Patent Application Publication
(10) Pub. No.: US 2018/0293310 A1
(43) Pub. Date: Oct. 11, 2018

(54) METHOD OF FINDING A DESIRED PORTION OF VIDEO WITHIN A VIDEO FILE AND DISPLAYING THE PORTION OF VIDEO ACCORDING TO STORED VIEW ORIENTATION SETTINGS

(71) Applicant: PRIMESTREAM CORPORATION, MIAMI, FL (US)

(72) Inventor: ALAN DABUL, AVENTURA, FL (US)

(21) Appl. No.: 15/484,635

(22) Filed: Apr. 11, 2017

(51) Int. Cl. G06F 17/30

(52) U.S. Cl. CPC G06F 17/30784; G06F 17/30607; G06F 17/30106

(57) ABSTRACT

A database has a plurality of markers that each include a time position, view orientation settings, and at least one text-based metadata field describing a portion of a video file. The metadata of the plurality of markers of the database are searched to find one or more of the plurality of markers having metadata matching input textual data. A list of each portion of the video file with the markers having the metadata matching the textual data is displayed. Then, a selected portion of the video file is displayed in an orientation specified by the view orientation settings stored in the marker of the selected portion of the video file. The markers are implemented as marker objects. A computer readable medium stores a set of computer executable instructions for performing the method.

### BACKGROUND OF THE INVENTION

### Field of the Invention

The invention relates to a method of finding a desired portion of video within a video file and displaying the desired portion of video. The invention also relates to a computer readable medium that stores a set of computer executable instructions for performing the method.

### Description of the Related Art

Particular portions of video in a video file that are desired due to some characteristics shown in the portions of the video are typically found manually by a person that views the video file. This is a time intensive process. Thus, there is a need for a better way to find desired portions of video in a video file. Also, when viewing a desired portion of video in a video player of a computer, the view orientation settings of the video player will be set to the default settings. Any changes to the view orientation settings need to be made when the desired portion of video in the video file is viewed in the video player.

### BRIEF SUMMARY OF THE INVENTION

It is an object of the invention to enable a desired portion of video in a video file to be found by searching for text-based metadata that has been previously stored in a marker, preferably, implemented as a marker object associated with the desired portion of video in the video file.

It is another object of the invention to cause the desired portion of video in the video file, which is found by searching the text-based metadata, to be displayed according to view orientation settings that have also been previously stored in the marker object along with the text-based metadata.

A database is preferably created by manually viewing a video file in a video player of a computer. Each time a portion of video in the video file is found that is of interest, that portion of video is marked using a marker that is preferably implemented as a marker object. This marker object stores information about the portion of video that is of interest. Position information, preferably, the time position of the portion of video, is stored in a field of the marker object so that the marker object identifies the position of the portion of video of interest in the video file. Thus, by finding the marker object, the portion of video that is of interest can be retrieved and viewed by instructing the video player to go to the time position that is stored in the marker object. Of course, the same process can be performed for a plurality of different video files, and marker objects associated with the plurality of different video files can be in the database.

Text metadata is also stored in a searchable field or fields of the marker object. This text metadata preferably describes some identifiable feature of the portion of video that is of interest. In one example that will be described later in this document, the text metadata is “looking right yellow helmet”. This text metadata will be searched by using text keywords or phrases that describe a certain feature or features that are of interest. In the Example given, perhaps it is desired to find portions of video in which a bicycle rider has a “yellow helmet”. It should be understood that more than one item or phrase of text metadata can be stored in the same marker object enabling different descriptive search terms to be used to find the same video portion of interest. For example, the metadata: “bicycle”, “bicycle rider”, and “yellow helmet” can all be stored in the same marker object to describe the portion of video identified by the time position stored in that marker object.

After the database is created, the text metadata stored in all of the marker objects in the database can be searched to find all of the marker objects containing text metadata matching desired search terms that are input into a computer. All of the marker objects containing text metadata matching the input search terms will be found during the search. Since each marker object stores a time position of the portion of video described by the text metadata stored in the marker object, the portion of video described by the text metadata of each marker object found by the search can be retrieved and viewed.

In addition to finding desired portions of video that are interest by searching the text metadata of the marker objects, the desired portions of video that are found by searching the text metadata of the marker object can be displayed in a specific way according to settings specified by view orientation settings that are also stored in the marker object. These view orientation settings preferably include an X or horizontal setting of a video player of a computer, a Y or vertical setting of the video player of the computer, and a zoom setting of the video player of the computer.

Thus, the marker object enables desired portions of video to be found by searching the text metadata, and also enables the desired portions of video to be displayed in a video player of a computer in a predefined way according to the view orientation settings that have been stored in the marker object.

In a preferred embodiment, the video file is 360° equirectangular video.

With the foregoing and other objects in view there is provided, in accordance with the invention, a method of finding and displaying a desired portion of a video file. A database having a plurality of markers is obtained. The markers are preferably objects, namely, marker objects. Each one of the markers includes a time position, view orientation settings for a portion of a video file and at least one text-based metadata field describing the portion of a video file. A user interface is displayed on a computer and this user interface enables the input of textual data into a video file database object. After the database is obtained or created, desired portions of video can be found by searching the text-based metadata fields of the markers. Thus, the method includes a step of searching, with the computer, the metadata of the plurality of markers of the database to find one or more of the plurality of markers having metadata matching the textual data in the video file database object. A list is displayed on the computer. The list includes one or more portions of a video file with the one or more of the plurality of markers having the metadata matching the textual data in the video file database object. A user interface is displayed on the computer and this user interface enables a selection of one of the portions of the video file in the list displayed on the computer. After an operator or user selects a particular portion of the video file in the displayed list, the selected portion of the video file is displayed on the computer in a view orientation specified by the view orientation settings in the metadata of the marker of the selected portion of the video file.

In accordance with an added feature of the invention, the view orientation settings include a horizontal setting of the video player, a vertical setting of the video player, and a zoom setting of the video player.

In accordance with an additional feature of the invention, the user interface enabling the input of textual data is displayed on the video player of the computer, the list of one or more portions of the video file is displayed on the display screen of the computer, for example, next to the video player shown on the display screen, and the user interface enabling the selection of one of the portions of the video file in the list is displayed on the video player of the computer.

With the foregoing and other objects in view there is also provided, in accordance with the invention, a non-transitory computer readable medium storing a set of computer executable instructions for performing the method.

Other features which are considered as characteristic for the invention are set forth in the appended claims.

Although the invention is illustrated and described herein as embodied in a method of finding a desired portion of video in a video file and displaying the portion of the video file according to stored view orientation settings, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 shows a flow chart illustrating a step of creating a database having marker objects;

FIG. 2 is a view of a video player;

FIG. 3 is another view of the video player;

FIG. 4 is a schematic diagram showing an example of a database having marker objects; and

FIG. 5 is another view of the video player.

### DESCRIPTION OF THE PREFERRED EMBODIMENTS OF THE INVENTION

It should be understood that the invention is not limited to any particular hardware or software platform. It should also be understood that the examples given herein are merely provided for explanatory purposes and that the invention should not be construed as being limited to the particular examples given herein.

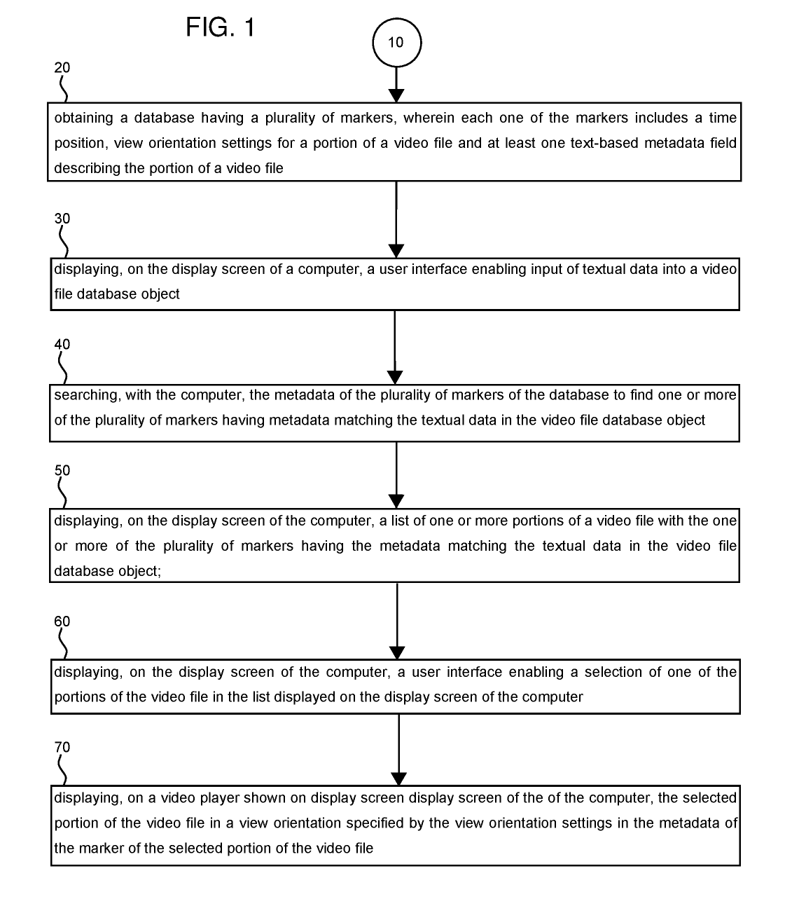

FIG. 1 shows a flow chart illustrating the steps of a method 10 of finding and displaying a desired portion of a video file. In this example, the video file is 360° equirectangular video. The method includes a step 20 of either creating a database or obtaining a database that has already been created. The created or obtained database stores information associating text-based metadata with the position of a particular video portion within a video file in a storage medium. The created or obtained database also stores information associating a particular portion of video of the video file with view orientation settings. This type of association or relationship is stored for many different portions of video within the video file. Thus, each respective portion of video is associated with: a unique position within the video file, text-based metadata specifically referring to that portion of video, and view orientation settings specific to that portion of video. Each respective portion of video of the video file will be a portion of video that is of interest because of certain characteristics of the images shown in that portion of video.

By using text search terms to search the text-based metadata, the position of a particular portion of video of a video file in a storage medium will be known because of the relationship between the text-based metadata and the position of that particular video portion within the video file. Also, due to the relationship between the stored view orientation settings and a particular portion of video, the stored view orientation settings can be used to set the view orientation parameters of a video player of a computer when viewing the particular portion of video that was found by searching the text-based metadata.

The step 20 of creating or obtaining the database includes providing the database with a plurality of markers that are preferably implemented as marker objects. Applicant refers to the marker objects using the names “Spatial Markers” and “Space Time Markers” and is filing trademark applications for those names. With the benefit of the disclosure provided herein, the person of ordinary skill in the art will understand that there are many suitable ways in which the marker objects can be designed to accomplish the goals of the invention. Thus, it should be understood that the invention is not limited to any particular design of a marker object.

Each one of the marker objects is preferably constructed to have a searchable field for storing the position of a respective portion of video within a video file. Preferably, the beginning position of the portion of video of the video file is stored. Also, since time codes are typically used for indicating the position, the field is preferably used for storing a time position of the beginning of the respective portion of video of the video file. However, the position of a respective portion of video within a video file could potentially be any type of indication of the position within the video file.

Each one of the marker objects is also constructed to have at least one searchable field for storing at least one item of text-based metadata relating to a respective video portion of interest of the video file. The text-based metadata is chosen to describe some identifiable characteristic or feature of the video portion of interest. In one example that will be described later in this document, the text metadata is “looking right yellow helmet”. This text metadata will be searched by using text keywords or phrases that describe a certain feature or features that are of interest. In the given example, perhaps a person or business wants to find portions of video in which a bicycle rider has a “yellow helmet”. It should be understood that more than one item or phrase of text metadata can be stored in the same marker object enabling different descriptive search terms to be used to find the same video portion of interest. For example, the metadata: “bicycle”, “bicycle rider”, and “yellow helmet” can all be stored in the same marker object to describe the video portion identified by the time position stored in that marker object.

Since each marker object stores the time position of a particular video portion of interest of a video file as well as text-based metadata describing that video portion, the marker object enables one to know the time position of that particular video portion when that marker object is returned in a list of search results due to searching the text-based metadata.

Each one of the marker objects is also constructed to have a field for storing view orientation settings or parameters of the associated portion of the video file. The view orientation settings or parameters preferably include an X or horizontal setting or parameter for indicating the horizontal viewing angle at which the portion of the video file is viewed in a video player on a computer. The view orientation settings or parameters also preferably include a Y or vertical setting or parameter for indicating the vertical viewing angle at which the portion of the video file is viewed in the video player on the computer. The view orientation settings or parameters also preferably include a zoom setting or parameter for indicating the zoom viewing position at which the portion of the video file is viewed in the video player on a computer.

The database can be created by the person or business desiring to perform a subsequent search on the database or it can be created by another business entity and subsequently distributed to the business desiring to perform a subsequent search on the database. The important aspect is that the database exists and that at least the text-based metadata of the marker objects can be searched. After the database is created, the database can be searched for marker objects storing text-based data that likely describes portions of video of interest.

In a general sense, the method also includes the following steps that are shown in FIG. 1. The method includes a step 30 of displaying, on a display screen of a computer, a user interface enabling input of textual data into a video file database object. The method includes a step 40 of searching, with the computer, the metadata of the plurality of markers of the database to find one or more of the plurality of markers having metadata matching the textual data in the video file database object. The method includes a step 50 of displaying, on the display screen of the computer, a list of one or more portions of a video file with the one or more of the plurality of markers having the metadata matching the textual data in the video file database object. The method includes a step 60 of displaying, on the display screen of the computer, a user interface enabling a selection of one of the portions of the video file in the list displayed on the computer. The method also includes a step 70 of displaying, on a video player shown on the display screen of the computer, the selected portion of the video file in a view orientation specified by the view orientation settings in the metadata of the marker of the selected portion of the video file.

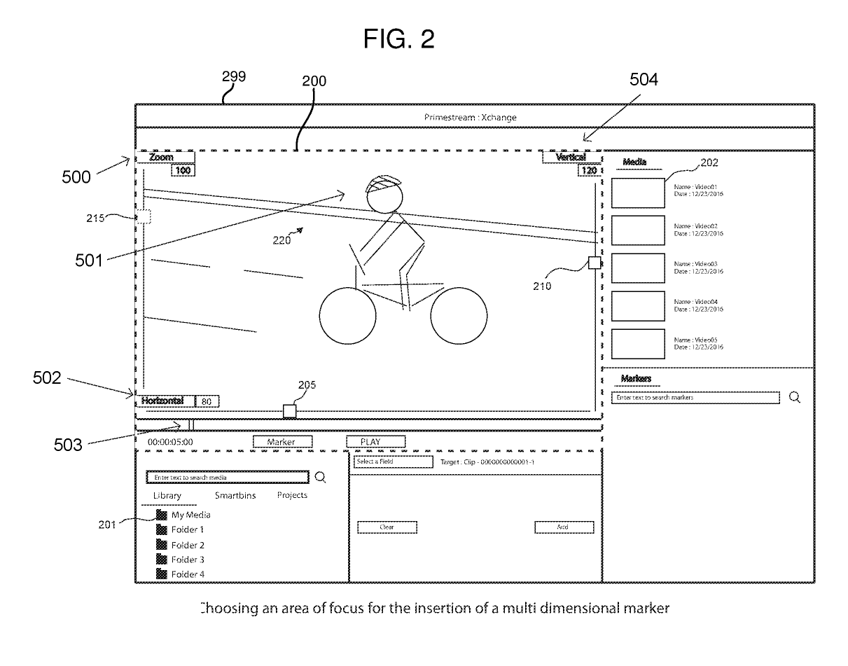

Let us now consider an example illustrating the way in which a marker object will be created for a video portion of interest. FIG. 2 is a view of a video player 200 shown on a display screen 299 of a computer. The video player 200 is shown using dashed lines. This video player 200 can be, for example, a Hyper Text Markup Language (HTML) 5 video player. In the example discussed below, the video player is the Xchange™ media player developed by Primestream™. However, the invention is certainly not limited to being implemented on this media player or by any specific media or video player.

The My Media folder 201 shown at the bottom left of the video player 200 is a search query that returns media objects specifying video files belonging to the user that is logged in. A list of media items or video files 202 is shown at the top right of the video player 200. The user clicks on the video file 202 to play it on the video player 200. In this example, the video file 202 is a 360° video in equirectangular projection. The video file is then loaded into the video player 200 and the video player 200 plays the video file. In this example, the video file is a 360° video in equirectangular projection.

The video player 200 has user interfaces for setting the view orientation at which video is viewed. These user interfaces are enabled by choosing the 360 Control toggle in the Xchange™ media player. These user interfaces include a horizontal slider 205, a vertical slider 210, and a zoom control slider 215. The settings of the horizontal slider 205, vertical slider 210, and zoom control slider 215 manipulate the view orientation of the 360° video that has been loaded into the video player 200. When the operator views a video portion of the video file that is of interest, the operator stops the progression of the video file on the video player 200, modifies the positions of the horizontal slider 205, vertical slider 210, and zoom control slider 215 in order to select a target location 200 within the displayed portion of the 360° video file 202. By modifying the positions of the horizontal slider 205, vertical slider 210, and zoom control slider 215, the view orientation is reoriented in accordance with the respective parameters entered into the video player 200 due to the settings of the sliders 205, 210, and 215. In this example, the horizontal slider 205, vertical slider 210, and zoom control are adjusted to supply parameters that target a cyclist with a yellow helmet.

Thus, in this example the target location 220 is the cyclist with a yellow helmet. After the target location 220 is selected, a marker object is created and information is stored in the marker object. Specifically, a value for the time position of the portion of the video showing the target location 220 is stored a particular marker object, and values for the parameters set by the positions of the horizontal slider 205, the vertical slider 210, and the zoom control slider 215 are also stored in the same marker object. Additionally, textual data, specifically, text-based metadata will also be stored in the marker object.

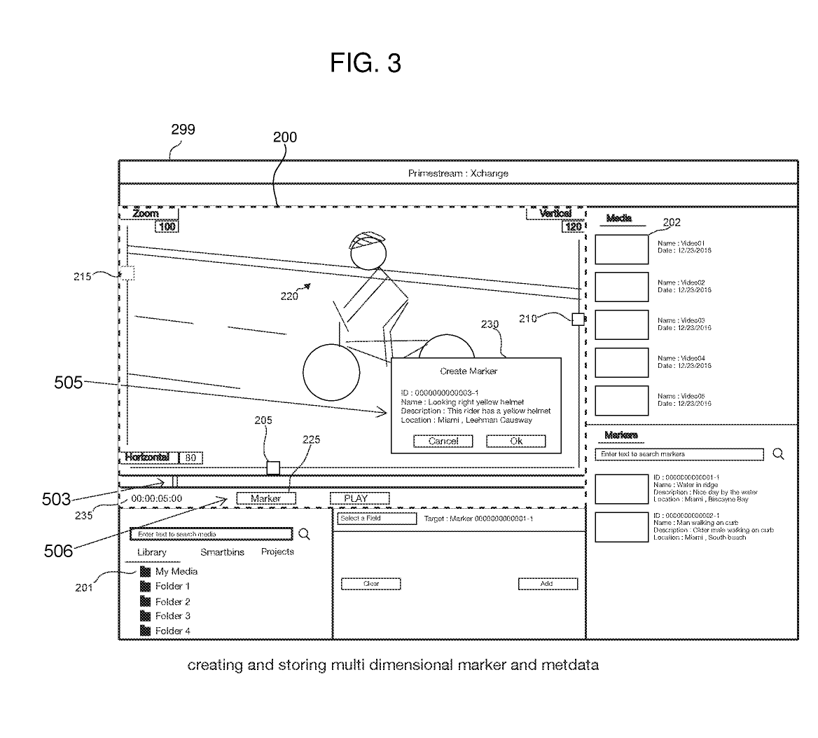

FIG. 3 is another view of the video player 200 shown on in FIG. 2. This figure shows an example of a user interface that is used to create the marker object. FIG. 3 shows the state after the operator has clicked on the “marker” button 225, which has activated at least one user interface in the form of at least one text box 230 for entering text-based metadata into a field of the marker object. In this example, the user interface has a text box 230 for entering a name for the marker object into a field of the marker object and for entering a description of the displayed portion of the video into a field of the marker object. A description indicating the location where the associated portion of the video file was filmed (i.e., Miami, Lehman Causeway) is also be entered into the text box 230. Preferably, the name, the description, and the location are all in searchable fields that allow the marker object to be listed in the list of the search results of a search for specific text-based metadata.

When the user clicks “Ok” to create the marker object, the time position 235 of the displayed video portion, the name of the marker object, the description, and the view orientation settings that have been set by the horizontal slider 205, the vertical slider 210, and the zoom control slider 215 are all saved into respective fields of the marker object.

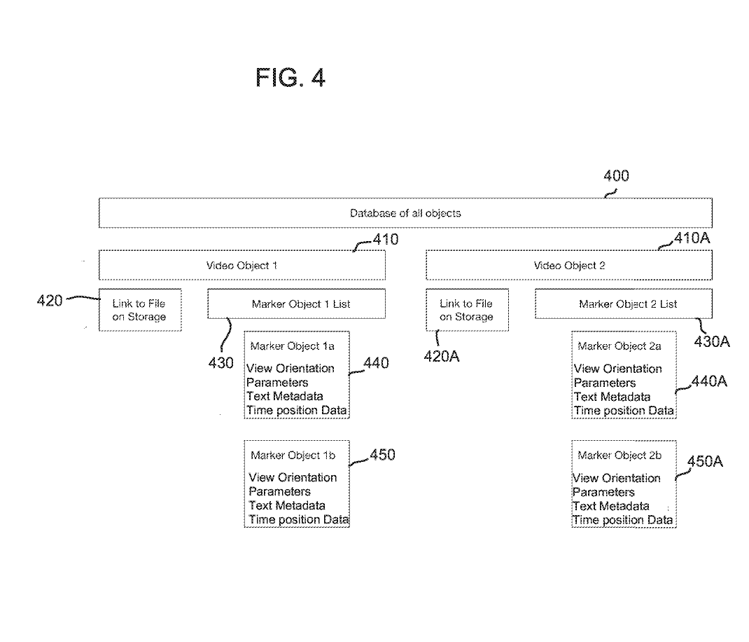

FIG. 4 is a schematic diagram showing an example of a database 400 having a plurality of marker objects 440, 450, 440A, and 450A. The database 400 contains a plurality of video objects 410, 410A. Of course, the database 400 will likely contain many more video objects than the video objects 410, 410A shown in the example provided to explain the invention. Each video object 410, 410A stores information that describes specific information about a respective video file.

In particular, each video object 410, 410A includes a link to a respective video file so that the video file can be retrieved from the correct storage location. Each video object 410 (or 410A) also includes a marker object list 430 (or 430A) informing the system of all the marker objects 440, 450 (or 440A, 450A) belonging to that video object 410 (or 410A). Of course, each video object 410 (or 410A) can contain many more marker objects than the two marker objects 440, 450 (or 440A, 450A) shown in the example provided to explain the invention. Each marker object 440, 450 (or 440A, 450A) includes the time position of a particular portion of video of the video file identified by the link 420 (or 420A). For example, the marker object 440 includes the time position of a first portion of video of the video file identified by the link 420. Another marker object 450 includes the time position of a second portion of video of the video file identified by the link 420. The second portion of video identified by the time position in the marker object 450 is preferably different from the first portion of video identified by the time position in the marker object 440. The marker object 440 includes text-based metadata describing the first portion of video of the video file identified by the link 420. Likewise, the marker object 450 includes text-based metadata describing the second portion of video of the video file identified by the link 420. The marker object 440 includes view orientation settings for setting the orientation in which the first portion of video of the video file, which is identified by the link 420, will be viewed in the video player of the computer. Likewise, the marker object 450 includes view orientation settings for setting the orientation in which the second portion of video of the video file, which is identified by the link 420, will be viewed in the video player of the computer.

The marker objects 440A and 450A in the marker object list 430A of the video object 410A are constructed to have logical relationships that are the same as those described above for the marker objects 440 and 450 in the marker object list 430 of the video object 410. Of course, here, the portions of video are portions of the video file identified by the link 420A. The marker objects 440, 450, 440A, and 450A could include information in addition to the specific information described herein.

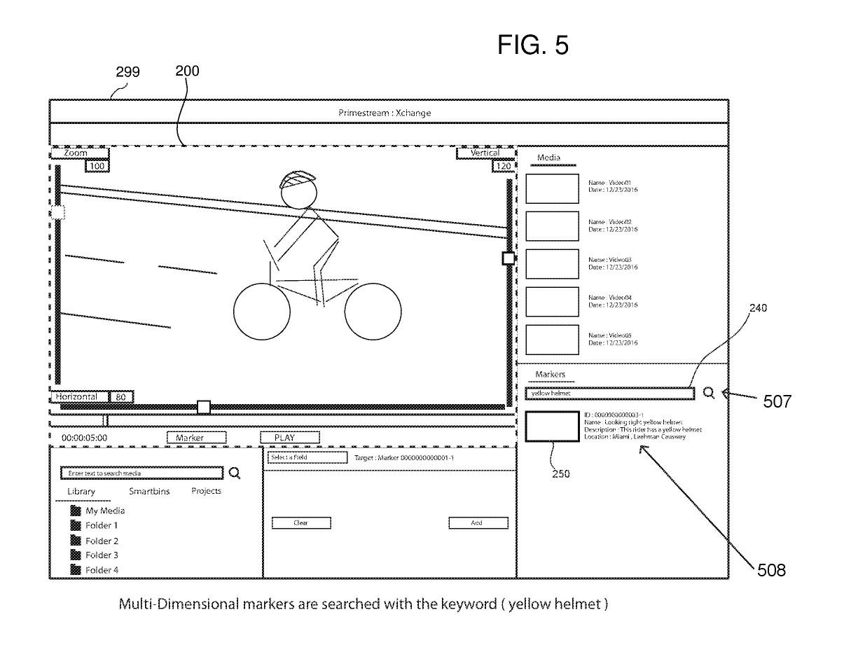

FIG. 5 is another view of the video player 200 shown in FIG. 2. FIG. 5 shows the video player 200 in a state after text data has been entered into a text box 240 and the marker objects 440, 450, 440A, 450A of the database 400 have been searched to find marker objects 440, 450, 440A, 450A with matching text. In this example, the user has typed the text, “yellow helmet” into the search box 240 and the system has sent a search Application Programming Interface (API) request to determine whether the text, “yellow helmet” can be matched with any of the metadata in the name, description, location, or possibly other fields of the marker objects 440, 450, 440A, 450A of the database 400. In this example, the search has found only one matching marker object. In this example, a screenshot 250 of the first frame of the portion of the video associated with the matching marker object is shown in the list. In the shown state of the video player 200, the user has already clicked on the screenshot 250 and the video player 200 shows the portion of the video associated with the matching marker object. While playing the portion of the video associated with the matching marker object, the view orientation settings of the video player 200 are set to the view orientation settings stored in the matching marker object.

I claim:

1. A method of finding and displaying a desired portion of a video file, the method which comprises:
obtaining a database having a plurality of markers, wherein each one of the markers includes a time position, view orientation settings for a portion of a video file and at least one text-based metadata field describing the portion of a video file;
displaying, on a display screen of a computer, a user interface enabling input of textual data into a video file database object;
searching, with the computer, the metadata of the plurality of markers of the database to find one or more of the plurality of markers having metadata matching the textual data in the video file database object;
displaying, on the display screen of the computer, a list of one or more portions of a video file with the one or more of the plurality of markers having the metadata matching the textual data in the video file database object;
displaying, on the display screen of the computer, a user interface enabling a selection of one of the portions of the video file in the list displayed on the display screen of the computer; and
displaying, on a video player shown on the display screen of the computer, the selected portion of the video file in a view orientation specified by the view orientation settings in the metadata of the marker of the selected portion of the video file.

2. The method according to claim 1, wherein the markers are objects.

3. The method according to claim 1, wherein the video file is 360° equirectangular video.

4. The method according to claim 1, wherein the view orientation settings include a horizontal setting of the video player, a vertical setting of the video player, and a zoom setting of the video player.

5. The method according to claim 1, wherein the user interface enabling the input of textual data is displayed on the video player of the computer, the list of one or more portions of the video file is displayed on the display screen of the computer, and the user interface enabling the selection of one of the portions of the video file in the list is displayed on the video player of the computer.

6. The method according to claim 1, wherein the step of obtaining the database having the plurality of markers includes:
loading a video file into the video player;
finding a portion of the video file that is of interest and orienting the view orientation by adjusting the view orientation settings; and
creating the marker with the time position of the portion of the video file that is of interest, the view orientation settings, and the at least one text-based metadata field describing the portion of the video file that is of interest.

7. The method according to claim 6, wherein the step of creating the marker includes:
storing a video object in the database, wherein the video object describes information about the portion of the video file that is of interest;
storing a marker object and a relation between the marker object and the video object in the database;
storing the time position of the portion of the video file that is of interest within the marker object;
inputting the textual data into the marker object via the computer; and
inputting the view orientation settings into the marker object via the computer.

8. A non-transitory computer readable medium storing a set of computer executable instructions for performing a method of finding and displaying a desired portion of a video file, the method which comprises:
obtaining a database having a plurality of markers, wherein each one of the markers includes a time position, view orientation settings for a portion of a video file and at least one text-based metadata field describing the portion of a video file;
displaying, on a display screen of a computer, a user interface enabling input of textual data into a video file database object;
searching, with the computer, the metadata of the plurality of markers of the database to find one or more of the plurality of markers having metadata matching the textual data in the video file database object;
displaying, on the display screen of the computer, a list of one or more portions of a video file with the one or more of the plurality of markers having the metadata matching the textual data in the video file database object;
displaying, on the display screen of the computer, a user interface enabling a selection of one of the portions of the video file in the list displayed on the display screen of the computer; and
displaying, on a video player shown on the display screen of the computer, the selected portion of the video file in a view orientation specified by the view orientation settings in the metadata of the marker of the selected portion of the video file.
